(19) United States
(12) Patent Application Publication
(10) Pub. No.: US 2026/0021505 A1
(43) Pub. Date: Jan. 22, 2026

(54) DEVICE AND METHOND FOR THE PREVENTION OF FREEZING OF SPRINKLERS

(71) Applicant: Thomas Leach Dyson, Lincolnton, NC (US)

(72) Inventor: Thomas Leach Dyson, Lincolnton, NC (US)

(21) Appl. No.: 18/779,175

(22) Filed: Jul. 22, 2024

(51) Int. Cl. B05B 15/14

(52) U.S. Cl. CPC B05B 15/14

(57) ABSTRACT

The present invention is a housing adapted for placement over a rotating sprinkler head. The housing is placed in a position to prevent water incursion into a spring arm structure of the sprinkler head without impeding the regular rotation of the sprinkler head. The housing can comprise a cover of unitary or two-part construction. The cover is arranged to fit over the nozzle bracket of an impact sprinkler head, and to fit with the impact arm of the sprinkler.

### CROSS-REFERENCE TO RELATED APPLICATIONS

Not Applicable

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISK APPENDIX

Not Applicable

### BACKGROUND OF THE INVENTION

### 1. Field of the Invention

The present invention relates to the field of agriculture and horticulture. More particularly, the invention relates to devices and methods of preventing the freezing of components of irrigation systems when such systems are utilized in sub-freezing temperatures.

### 2. Background of the Invention

Many fruit, vegetable, and nursery crops are grown in areas in which the onset of low temperatures can result in frost or freeze damage to the crops. Such circumstances can cause severe crop losses. The most severe damage usually occurs when a freeze or frost takes place after buds and blossoms have begun to open. A severe freeze can also damage fruit which is already set, damage foliage, and can even kill limbs or entire plants. The degree of injury inflicted by low temperatures depends on a number of factors, including the type of variety of plant and the stage of development of the crop. Most crops will not be damaged if a freeze occurs while the plant is dormant. On the other hand, damage can be severe if a freeze occurs after buds and blossoms begin to open. Other factors that can be important include the amount of leaf cover over the blossoms and fruit, the severity and duration of the freeze, and the wind speed. Cooler temperatures, for longer periods of time are worse. Wind speed can actually mitigate the damage, as a slight breeze-about 4 or 5 mph-will prevent frost from forming so long as the temperature remains above 32° F.

Fruit, vegetable, and nursery farmers use various methods to minimize the effects of freezing temperatures. Some of the more common methods include orchard heaters, wind machines, and overhead sprinkler irrigation. There are advantages and disadvantages to each of these methods.
(1) Orchard Heaters: Orchard heaters have been used for centuries to protect orchards. Most heaters are designed to burn oil and can be placed as freestanding units or supplied by a pipeline network throughout the orchard. Propane, liquid petroleum and natural gas have also been used as fuels. The initial cost is generally lower than for other systems, but the cost of the fuel makes this system the most expensive in terms of operating cost.
(2) Wind Machines: Wind machines can be effective during a radiation frost. Their purpose is to circulate warmer air down to orchard level. A single wind machine can protect up to 10 acres. A typical wind machine is a large fan about 16 feet in diameter mounted on a 30 foot steel tower. The fan is typically powered by an industrial engine delivering 85 to 100 horsepower. Helicopters have been used as wind machines. They hover in one spot until the temperature increases, then they move to the next area. Repeated visits to the same area are usually necessary during a typical frost.
(3) Sprinkler Irrigation: Overhead irrigation is probably the most commonly used means of frost/freeze protection in the southeastern United States. In this method, water is applied to the plants through an overhead sprinkler irrigation system. Heat lost from the plant part to its environment is replaced by heat released as the applied water changes to ice. As long as water is supplied at an adequate rate, the temperature of the plant will remain at or near 32° F. Advantages of overhead irrigation include lower operating cost, convenience to operate, and the other multiple uses of the system, such as drought prevention, heat suppression, fertilizer application.

The terms frost and freeze are often used interchangeably, but they are actually two separate conditions. An advective or windborn freeze occurs when a cold air mass moves into an area bringing freezing temperatures. Wind speeds are usually above five miles per hour and clouds may be present. Due to the high wind velocities, cold protection is very limited during an advective freeze.

On the other hand, a radiation frost occurs on clear nights with calm winds. Air temperatures near the ground surface drop below freezing and there is normally warmer air higher in the atmosphere. This phenomenon is known as an inversion. Radiation frosts are usually shorter in duration than an advective freeze.

Frost protection by irrigation is most effective during radiation frost conditions. In using overhead irrigation for frost/freeze protection, the heat lost from the plant to its environment is replaced by the heat released when water changes to ice. Specifically, as one pound of water freezes, 144 BTU of heat energy are liberated. This is called the latent heat of fusion of water. As long as liquid water is freezing on the plant at all times, the surface temperature will remain at or near 32° F. Adequate water must be applied to compensate for heat losses by radiation, convection and evaporation. If the irrigation rate is not adequate, the damage may be more severe than if no protection had been provided. If wind velocities are high and/or if relative humidities are low, water may evaporate from the plant surfaces. If this occurs, evaporative cooling will actually lower the temperature of the plant. As one pound of water evaporates 1080 BTU of heat energy are absorbed from the surrounding environment. When compared to the 144 BTU released by freezing it becomes apparent that 7½ times more water must be freezing than evaporating in order to have a net heating effect. For this reason, frost/freeze protection by irrigation is not usually recommended if wind velocities exceed five miles per hour. If the relative humidity is low, the sprinkler system should be started at a higher than usual temperature to compensate for the evaporative cooling that will occur as the first water strikes the plants.

Typically, sprinkler systems should be started when the air temperature in the orchard or field reaches 34° F. It should operate continuously until the air temperature increases to above 32° F. and the ice on the plants has begun to melt. The ultimate goal of frost/freeze protection is to prevent plant parts (particularly the flowers and fruit) from being damaged by temperatures that drop below the critical level. This critical temperature varies from crop to crop and also depends on the stage of flower and fruit development. On evenings when freezing night temperatures are expected, temperatures should be checked at least hourly. The thermometer(s) should be placed at the level of the plants in a low spot in the field exposed to the open sky. Accurate thermometers should be used and they should be checked prior to use by placing them in a container of well stirred ice water. If accurate they should read 32° F. Typically, the sprinkler system should be started when the temperature reaches 34° F. If the relative humidity is low the system may need to be started at a slightly higher temperature. If a source of power is available a thermostat may be wired to switch on a warning bell when the temperature drops to a predetermined setting (usually 36° to 38° F.).

The design of overhead irrigation systems for frost/freeze protection can be important. The desired precipitation rate for adequate cold protection will depend on the crop to be protected. For low growing crops such as strawberries, the precipitation rate should be between 0.12 and 0.15 inches per hour; medium sized plants such as blueberries and grapes need 0.14 to 0.16 inches per hour; and large trees such as apples and peaches need 0.16 to 0.18 inches per hour. As a general rule precipitation rates should not exceed 0.2 inches per hour. At these high rates run-off becomes excessive and excessive ice build-up on trees causes increased damage from broken limbs.

The precipitation rate applied by a sprinkler irrigation system will depend on the sprinkler discharge and the spacing between sprinklers. Generally, the desired sprinkler spacing will be determined first and then a sprinkler will be selected with an appropriate discharge rate and wetted diameter. Sprinklers are typically spaced in the range of 40×40 feet to 80×80 feet. The precise spacing will often depend on the spacing of the crop to be watered. For tree crops, it is desirable to have a row of sprinklers in every other tree row in order to provide adequate coverage over the whole tree. Also, the outside row of sprinklers should be located at the edge of the field to provide adequate coverage for the outside row of trees. In order to provide uniform coverage, sprinkler spacing should be from 50 to 60 percent of the wetted diameter of the sprinkler. Under no circumstances should the spacing exceed 70 percent of the effective sprinkler diameter. Typically, every other row of sprinklers is staggered to provide a triangular pattern; however sprinklers may also be spaced in a square or rectangular pattern.

Varying types of irrigation sprinklers are used to protect against freeze/frost damage to crops. The basic design of sprinklers is that water is distributed through a network that may consist of pumps, valves, pipes, and sprinklers. Commonly, the system is basically perpendicular pipes, having rotating nozzles on top. When water is pressurized through the pipes, it escapes from the rotating nozzles, sprinkling water on the crop. Sprinklers can be driven in a circle by a ball drive, gear drive, or impact mechanism. Each of these types can be designed to rotate in a full or partial circle.

Any suitable sprinkler known to those in the art may be potentially used for frost and freeze protection. Such sprinklers should be constructed of brass or some other metal, as plastic sprinklers may become brittle and break during freezing temperatures. Any equipment failure during the middle of a freeze could cause catastrophic crop failure. In addition, sprinklers should have a fairly rapid rotational speed-at least one revolution per minute. Single nozzle sprinklers are commonly used in order to achieve the low application rates desired.

Impact sprinklers are commonly used for frost and freeze protection. An impact sprinkler is a type of irrigation sprinkler in which the sprinkler head is driven in a circular motion by the force of the outgoing water, and pivots on a bearing on top of a threaded attachment nut. In many cases, gear-driven rotary head sprinklers can be similarly used. The impact sprinkler operates with the sprinkler head pivoting on a bearing on top of its threaded attachment nut. The head is driven in a circular motion by the force of the outgoing water, and at least one arm extends from the head. The sprinkler arm is repeatedly pushed back into the water stream by a spring. The arm's striking the water stream scatters the stream and re-orients the flow slightly, enabling a uniform watering area around the sprinkler.

FIG. 1 depicts an impact sprinkler of a type known in the art. This sprinkler operates with the water passing through the body of the sprinkler, then through the nozzle, finally into the curve of the spoon end of the impact arm. The reactionary force of the water leaving the spoon drives the arm out of the stream and away from the nozzle. The tension of the arm spring then pulls the arm back into the original position where it impacts on the bridge or nozzle, causing the sprinkler to turn.

When used during cold weather, the water drips or blows back onto the arm spring and may freeze as temperatures drop to extremes. Ice accumulates such that the spring can no longer reciprocate, and the turning motion is stopped. As discussed above, this ceasing of the operation of the sprinkler can be catastrophic, as the freezing and frost damage is not prevented.

Applicant has searched for a method or device to prevent this catastrophic freezing of the sprinkler devices used to prevent frost and freeze damage of crops, but has found no cost-effective method that consistently functions properly. There is clearly a need for methods and devices for prevention of freezing of sprinklers used in the efforts to prevent freezing and frost damage to crops.

### BRIEF SUMMARY OF THE INVENTION

It is an object of the present invention to provide a correctly shaped cover for the head of a sprinkler, for placement on the sprinkler head, to prevent the water from the active sprinkler from settling in the works of the sprinkler and freezing. It is a further object of the present invention to provide the structure necessary to attach the cover without impeding the use of the sprinkler. It is a further object of the present invention to provide a method of preventing freezing of sprinklers during their use in cold weather by application of the cover.

This summary of the invention does not necessarily describe all features of the invention.

### BRIEF DESCRIPTION OF THE DRAWINGS These and other features of the invention will become more apparent from the following description in which reference is made to the appended drawings wherein:

FIG. 1 is a view of an impact sprinkler of the prior art

FIG. 2A is a front view of a first embodiment of the present invention.

FIG. 2B is another view of a first embodiment of the present invention.

FIG. 2C is another view of a first embodiment of the present invention.

FIG. 3A is a front view of a first embodiment of the present invention.

FIG. 3B is another view of a first embodiment of the present invention.

FIG. 3C is another view of a first embodiment of the present invention.

FIG. 4A is a front view of a first embodiment of the present invention.

FIG. 4B is another view of a first embodiment of the present invention.

FIG. 4C is another view of a first embodiment of the present invention.

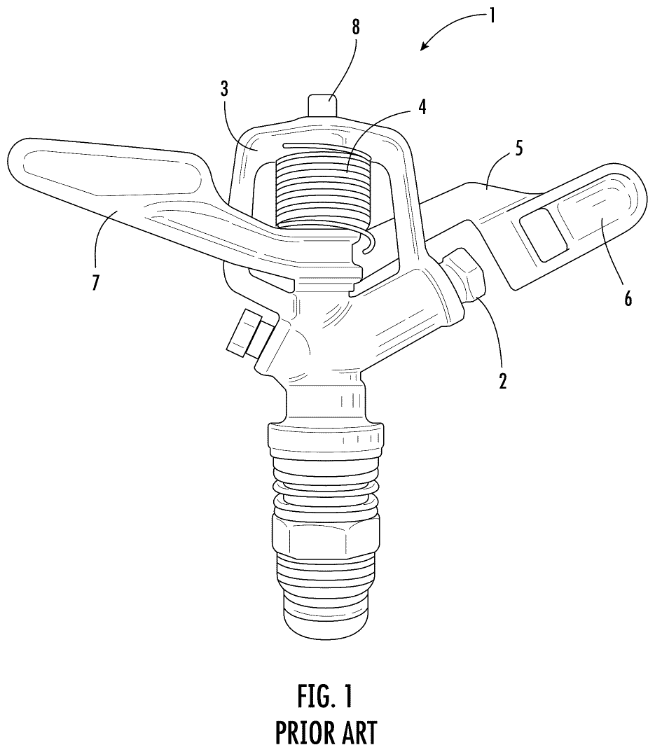

### REFERENCE NUMERALS IN THE DRAWINGS

1 Impact Sprinkler Head
2 Nozzle
3 Nozzle Bracket
4 Spring Arm Structure
5 Impact Arm
6 First Spoon End of Impact Arm
7 Second End of Impact Arm
8 Fulcrum Pin
9 Housing
10 Unitary Cover
11 Open First End of Unitary Cover
12 Closed Second End of Unitary Cover
13 Single Notch of Unitary Cover
First Seating Gap
15 Second Seating Gap
16 First Clip
17 Second Clip
18 Cavity
19 First Notch of Unitary Cover
20 Second Notch of Unitary Cover
21 Two-Part Cover
22 Saddle Cup
23 Sealing Cup
24 Open First End of Saddle Cup
25 Closed Second End of Saddle Cup
26 Single Notch of Saddle Cup
27 Hole in second End of Saddle Cup
28 Retainer Ring
29 Open First End of Sealing Cup
30 Closed Second End of Sealing Cup cl DETAILED DESCRIPTION OF VARIOUS EMBODIMENTS OF THE INVENTION

Various embodiments of the invention are described more fully hereinafter with reference to the accompanying drawings, in which some, but not all embodiments of the invention are shown in the figures. Indeed, these inventions may be embodied in many different forms and should not be construed as limited to the embodiments set forth herein; rather, these embodiments are provided so that this disclosure will satisfy applicable legal requirements.

The invention comprises a housing that serves as a cover for the nozzle bracket of an impact sprinkler head. Various configurations of the invention are within the scope of the invention, and several variations are described herein.

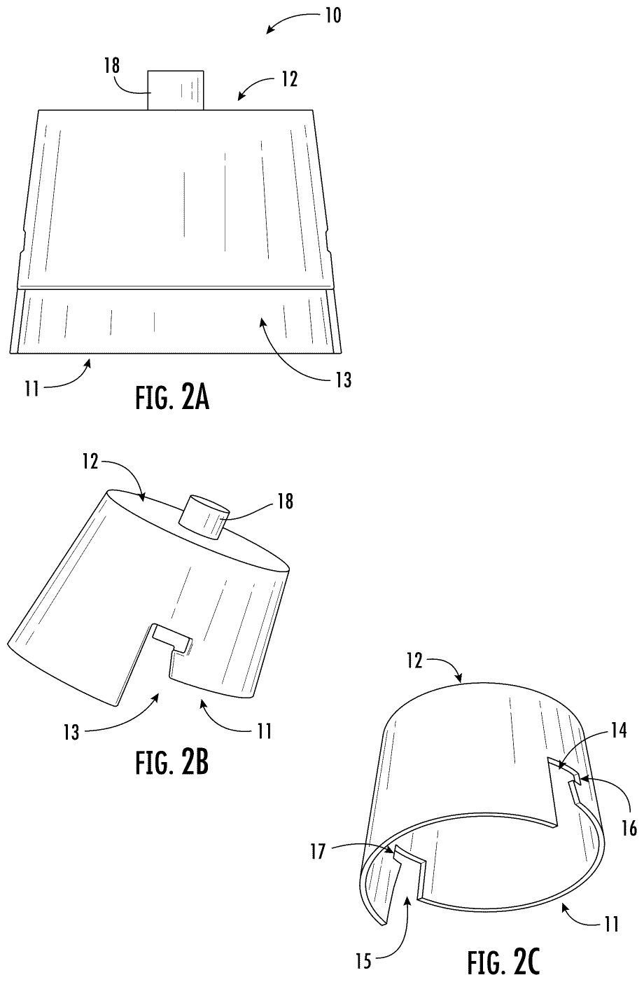

The housing may interact with the impact sprinkler head in several different arrangements. A first embodiment of the present invention is shown in FIGS. 2A through 2C. In the embodiment, the invention comprises a housing having a unitary cover 10 arranged to fit over the nozzle bracket 3 of an impact sprinkler head 1. The cover can be of any shape known in the art, but is advantageously arranged in a cylindrical or cup-shape. The cover 10 is open at a first end 11 and closed at a second end 12. In the first embodiment, the cover 10 is sized to fit over the nozzle bracket 3 of an impact sprinkler head 1, with said cover enclosing the nozzle bracket 3. The cover comprises a single notch 13 in the open first end 11 of the cover, arranged to fit over the impact arm 5 immediately adjacent the nozzle bracket 3 toward the first spoon end 6 of the end of the impact arm 5. The single notch 13 extends to the distance to fit over the impact arm 5 immediately adjacent the nozzle bracket toward the second end of the impact arm 7, opposite the spoon end. In the embodiment, the cover further comprises seating gaps 14 and 15 arranged at both ends of the single notch. The seating gaps may further comprise a first clip 16 for attaching the cover to the impact arm at the first end of the notch, and a second clip 17 for attaching the cover to the impact arm at the second end of the notch. The cover further comprises a cavity 18 extending outward from the closed second end 12 of the cover, said cavity sized and arranged to engage with the distal end of fulcrum pin 8, such that the distal end of the fulcrum pin is seated within the cavity. Upon rotation of the cover, it remains centered over the nozzle bracket, preventing water incursion into the spring arm structures 4 located adjacent the nozzle bracket.

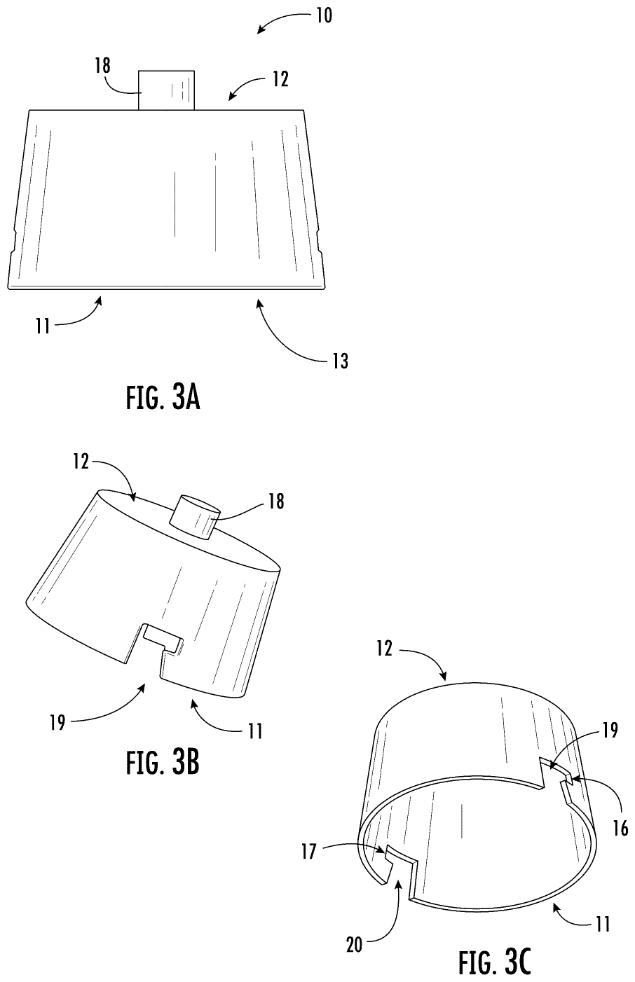

A second embodiment of the present invention is shown in detail in FIGS. 3A through 3C. The embodiment shown in FIGS. 3A through 3C comprises a housing 9 having a unitary cover 10 arranged to fit over the nozzle bracket 3 of an impact sprinkler head 1. The cover can be of any shape known in the art, but is advantageously arranged in a cylindrical or cup-shape. The cover 10 is open at a first end 11 and closed at a second end 12. In the first embodiment, the cover 10 is sized to fit over the nozzle bracket 3 of an impact sprinkler head 1, with said cover enclosing the nozzle bracket 3. The cover in this embodiment comprises two notches, including a first notch 19 in the open first end 11 of the cover, arranged to fit snuggly with the impact arm 5 immediately adjacent the nozzle bracket 3 toward the first spoon end 6 of the end of the impact arm 5. The cover further comprises a second notch 20 in the open first end 11 of the cover, arranged to fit snuggly with the impact arm 5 immediately adjacent the nozzle bracket toward the second end of the impact arm 7, opposite the spoon end. The cover further comprises a cavity 18 extending outward from the closed second end 12 of the cover, said cavity sized and arranged to engage with the distal end of fulcrum pin 8, such that the distal end of the fulcrum pin is seated within the cavity. Upon rotation of the cover, it remains centered over the nozzle bracket, preventing water incursion into the spring arm structures 4 located adjacent the nozzle bracket.

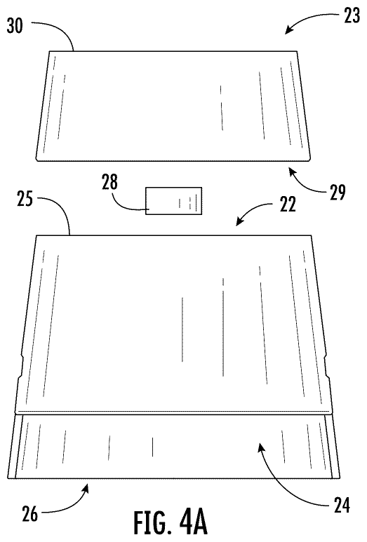

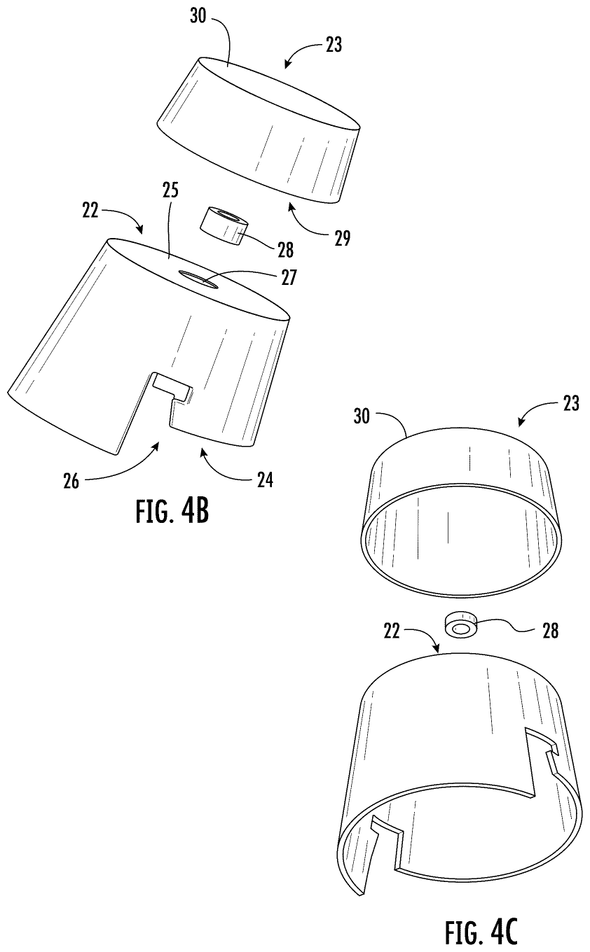

A third embodiment of the present invention is shown in detail in FIGS. 4A through 4C. The invention comprises a housing 9 having a two-part cover 21 arranged to fit over the nozzle bracket 3 of an impact sprinkler head 1. The first part of the cover 21 is the saddle cup 22. Though described as a cup, the cover and its parts can be of any shape known in the art, but is advantageously arranged in a cylindrical or cup-shape. The saddle cup 22 is open at a first end 24 and closed at a second end 25. The saddle cup 22 is sized to fit over the nozzle bracket 3 of an impact sprinkler head 1, with said saddle cup enclosing the nozzle bracket 3. The saddle cup comprises a single notch 26 in the open first end 24 of the cover, arranged to fit over the impact arm 5 immediately adjacent the nozzle bracket 3 toward the first spoon end 6 of the end of the impact arm 5. The single notch 26 extends to the distance to fit over the impact arm 5 immediately adjacent the nozzle bracket toward the second end of the impact arm 7, opposite the spoon end. The saddle cup further comprises a hole 27 extending through the substantially central portion of the closed second end 25 of the saddle cup, said hole sized and arranged to engage loosely with the distal end of fulcrum pin 8. The saddle cup 22 is affixed to the end of the fulcrum pin with a retainer ring 28. Upon rotation of the cover, it remains centered over the nozzle bracket.

The second part of the two-part cover is the sealing cup 23. The sealing cup is described as cup, but it can be of any shape known in the art. It is advantageously arranged in a cylindrical or cup-shape. The sealing cup 23 is open at a first end 29 and closed at a second end 30. The sealing cup 23 is sized to fit over the saddle cup 22, extending partly along the length of the saddle cup. The sealing cup is secured to the saddle cup by any method of attachment or adhesives as known to those skilled in the art. Upon rotation of the cover, the entire two-part cover remains centered over the nozzle bracket, and prevents water incursion into the spring arm structures located adjacent nozzle bracket.

The present invention is a housing adapted for placement over a rotating sprinkler head, wherein said housing is placed in a position to prevent water incursion into a spring arm structure of said sprinkler head without impeding the regular rotation of the sprinkler head.

In a further embodiment, the present invention is a housing adapted for placement over a rotating impact sprinkler head. The housing has a unitary cover arranged to fit over the nozzle bracket of an impact sprinkler head, with the cover having an open first end and a closed second end. The cover has a single notch in the open first end. The notch extends from a point fitting over an impact arm of said rotating impact sprinkler head upon an end of the impact arm toward a first spoon end of said impact arm, adjacent said nozzle to a point bracket, and a point fitting over an impact arm of said rotating impact sprinkler head upon a second end of the impact arm, opposite the spoon end, adjacent said nozzle bracket.

In a further embodiment, the cover is cylindrically shaped.

In a further embodiment, the housing comprises a first clip for attaching the cover to the impact arm at the first end of the single notch, and a second clip for attaching the cover to the impact arm at the second end of the single notch.

In a further embodiment, the cover comprises a cavity extending outward from the closed second end of the cover, said cavity sized and arranged to engage with the distal end of a fulcrum pin of said rotating impact sprinkler head, such that the distal end of the fulcrum pin is seated within the cavity.

In a further embodiment, the present invention is a housing adapted for placement over a rotating impact sprinkler head. The housing has a unitary cover arranged to fit over the nozzle bracket of an impact sprinkler head, said cover having an open first end and a closed second end. The cover has first and second notches in the open first end. The first notch is arranged to fit snuggly with an impact arm of said rotating impact sprinkler head upon an end of the impact arm toward a first spoon end of said impact arm, adjacent said nozzle bracket. The second notch is arranged to fit snuggly with the impact arm of said rotating impact sprinkler head upon a second end of the impact arm, opposite the spoon end, adjacent said nozzle bracket.

In a further embodiment, the cover is cylindrically shaped.

In a further embodiment, the housing comprises a first clip for attaching the cover to the impact arm at the first notch, and a second clip for attaching the cover to the impact arm at the second notch.

In a further embodiment, the cover comprises a cavity extending outward from the closed second end of the cover, said cavity sized and arranged to engage with the distal end of a fulcrum pin of said rotating impact sprinkler head, such that the distal end of the fulcrum pin is seated within the cavity.

In another embodiment, the present invention is a housing adapted for placement over a rotating impact sprinkler head, comprising a two-part cover arranged to fit over the nozzle bracket of an impact sprinkler head. The two-part cover comprises a saddle cup and a sealing cup. The saddle cup has an open first end and a closed second end, and has first and second notches in the open first end thereof. The first notch is arranged to fit snuggly with an impact arm of said rotating impact sprinkler head upon an end of the impact arm toward a first spoon end of said impact arm. The second notch is arranged to fit snuggly with the impact arm of said rotating impact sprinkler head upon a second end of the impact arm, opposite the spoon end, adjacent said nozzle bracket. The sealing cup also has an open first end and a closed second end, and the sealing cup is sized to fit over said saddle cup, extending partly along the length of the saddle cup.

In a further embodiment, the two-part cover further comprises a securement to affix said sealing cup to said saddle cup. Such securement could be any known in the art, such as clips or adhesives.

In a further embodiment, the saddle cup further comprises a hole extending through the substantially central portion of the closed second end of the saddle cup. The hole is sized and arranged to engage with a distal end of a fulcrum pin of a rotating impact sprinkler. The saddle cup is affixed to the end of the fulcrum pin with a retainer ring.

In a further embodiment, the present invention is a method of preventing freezing of a rotating water sprinkler during its use in cold weather by application of the cover sufficient to prevent water incursion into a spring arm structure of said sprinkler head without impeding the regular rotation of the sprinkler head.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above described embodiment, method, and examples, but by all embodiments and methods within the scope and spirit of the invention as claimed. Moreover, the terms “consisting”, “comprising” and other derivatives from the term “comprise” are intended to be open-ended terms that specify the presence of any stated features, elements, steps, or components, and are not intended to preclude the presence or addition of one or more other features, elements, integers, steps, components, or groups thereof. Moreover, Applicants have endeavored in the present specification and drawings to draw attention to certain features of the invention, it should be understood that the Applicant claims protection in respect to any patentable feature or combination of features referred to in the specification or drawings. The drawings are provided to illustrate features of the invention, but the claimed invention is expressly not limited to the illustrated embodiments.

I claim:

1. A housing adapted for placement over a rotating sprinkler head, wherein said housing is placed in a position to prevent water incursion into a spring arm structure of said sprinkler head without impeding the regular rotation of the sprinkler head.

2. The housing of claim 1, adapted for placement over a rotating impact sprinkler head, comprising:
a. A unitary cover arranged to fit over the nozzle bracket of an impact sprinkler head, said cover having an open first end and a closed second end, and
b. Said cover having a single notch in the open first end, wherein, said notch extends from a point fitting over an impact arm of said rotating impact sprinkler head upon an end of the impact arm toward a first spoon end of said impact arm, adjacent said nozzle to a point bracket, and a point fitting over an impact arm of said rotating impact sprinkler head upon a second end of the impact arm, opposite the spoon end, adjacent said nozzle bracket.

3. The housing in claim 2, wherein said cover is cylindrically shaped.

4. The housing of claim 2, wherein said cover further comprises a seating gap for seating the cover with the a first end of said impact arm, and a second seating gap for seating the cover with a second end of said impact arm.

5. The housing of claim 2, wherein said cover further comprises a small cavity extending outward from the closed second end of the cover, said cavity sized and arranged to engage with the distal end of a fulcrum pin of said rotating impact sprinkler head, such that a distal end of the fulcrum pin is seated within the cavity.

6. The housing of claim 1, adapted for placement over a rotating impact sprinkler head, comprising:
a. A unitary cover arranged to fit over the nozzle bracket of an impact sprinkler head, said cover having an open first end and a closed second end, and
b. Said cover having first and second notches in the open first end, wherein,
c. Said first notch is arranged to fit snuggly with an impact arm of said rotating impact sprinkler head upon an end of the impact arm toward a first spoon end of said impact arm, adjacent said nozzle bracket, and
d. said second notch is arranged to fit snuggly with the impact arm of said rotating impact sprinkler head upon a second end of the impact arm, opposite the spoon end, adjacent said nozzle bracket.

7. The housing in claim 6, wherein said cover is cylindrically shaped.

8. The housing of claim 6, wherein said cover further comprises a first clip for attaching the cover to the impact arm at the first notch, and a second clip for attaching the cover to the impact arm at the second notch.

9. The housing of claim 6, wherein said cover further comprises a small cavity extending outward from the closed second end of the cover, said cavity sized and arranged to engage with the distal end of a fulcrum pin of said rotating impact sprinkler head, such that a distal end of the fulcrum pin is seated within the cavity.

10. The housing of claim 1, adapted for placement over a rotating impact sprinkler head, comprising:
a. A two-part cover arranged to fit over the nozzle bracket of an impact sprinkler head,
b. said cover comprising a saddle cup and a sealing cup,
c. said saddle cup having an open first end and a closed second end,
d. said saddle cup having first and second notches in the open first end thereof, wherein, said first notch is arranged to fit snuggly with an impact arm of said rotating impact sprinkler head upon an end of the impact arm toward a first spoon end of said impact arm, adjacent said nozzle bracket, and said second notch is arranged to fit snuggly with the impact arm of said rotating impact sprinkler head upon a second end of the impact arm, opposite the spoon end, adjacent said nozzle bracket,
e. said sealing cup having an open first end and a closed second end, and said sealing cup sized to fit over said saddle cup, extending partly along the length of the saddle cup.

11. The housing of claim 10, wherein said two-part cover further comprises a securement to affix said sealing cup to said saddle cup.

12. The housing of claim 10, wherein said saddle cup further comprises a small hole extending through the substantially central portion of the closed second end of the saddle cup, said hole sized and arranged to engage with a distal end of a fulcrum pin of a rotating impact sprinkler.

13. The housing of claim 12, further comprising a retainer ring for securing said saddle cup to said distal end of said fulcrum pin.

14. A method of preventing freezing of a rotating water sprinkler during its use in cold weather by application of a cover sufficient to prevent water incursion into a spring arm structure of said sprinkler head without impeding the regular rotation of the sprinkler head.
